(19) United States
(12) Patent Application Publication
(10) Pub. No.: US 2014/0215098 A1
(43) Pub. Date: Jul. 31, 2014

(54) DOCKING DISPLAY ADAPTER WITH AUTOMATIC MODE SWITCHING

(71) Applicant: INTEL CORPORATION, Santa Clara, CA (US)

(72) Inventor: Charles L. Brabenac, Portland, OR (US)

(21) Appl. No.: 13/997,698

(22) PCT Filed: Feb. 13, 2012
(86) PCT No.: PCT/US2012/024875

§ 371 Date: Sep. 13, 2013

(51) Int. Cl. G06F 3/02; G06F 1/16

(52) U.S. Cl. CPC G06F 3/0227; G06F 1/1632
USPC 710/14

(57) ABSTRACT

A display adapter for docking one or more clients to a display and providing automatic mode switching of the display. The display adapter including a client interface circuit configured to receive client data from the one or more clients; a processing circuit configured to determine a display mode based on the client data; and a display interface circuit configured to transmit the display mode to the display.

### FIELD

The present disclosure relates to docking display adapters, and more particularly, to docking display adapters with automatic display mode switching.

### BACKGROUND

Display adapters or docking stations allow multiple clients to alternately connect to a display. Each client, however, may have a different display mode requirement. For example, an enterprise notebook PC client may be primarily interested in productivity and thus have a desired display mode that provides the highest quality text rendering possible on that display. Alternatively, a desktop gaming PC client may have, as a desired configuration, a gaming mode where image post-processing in the display is turned off to decrease latency.

Generally, when the display adapter switches from one client to another, a user must manually change the display mode and settings by pushing a sequence of buttons or using an infra-red (IR) remote control to issue commands to the display. This can be a cumbersome process, particularly when the clients are remote and coupled to the display adapter through a wireless connection.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a top level system diagram of another exemplary embodiment consistent with the present disclosure;

FIG. 3 illustrates a system block diagram of one exemplary embodiment consistent with the present disclosure;

FIG. 4 illustrates a data channel of one exemplary embodiment consistent with the present disclosure; and

FIG. 5 illustrates a flowchart of operations of one exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides an apparatus and method to automatically switch a display mode, and/or other settings associated with a display, in response to a change of clients connecting through a display adapter. In some embodiments the display adapter may be a wireless docking display adapter through which the clients may be remotely accessing the display. The wireless connection may be a Wireless Fidelity (Wi-Fi) connection, a 60 GHz connection or any other suitable wireless connection. In some embodiments the display adapter may be integrated with the display.

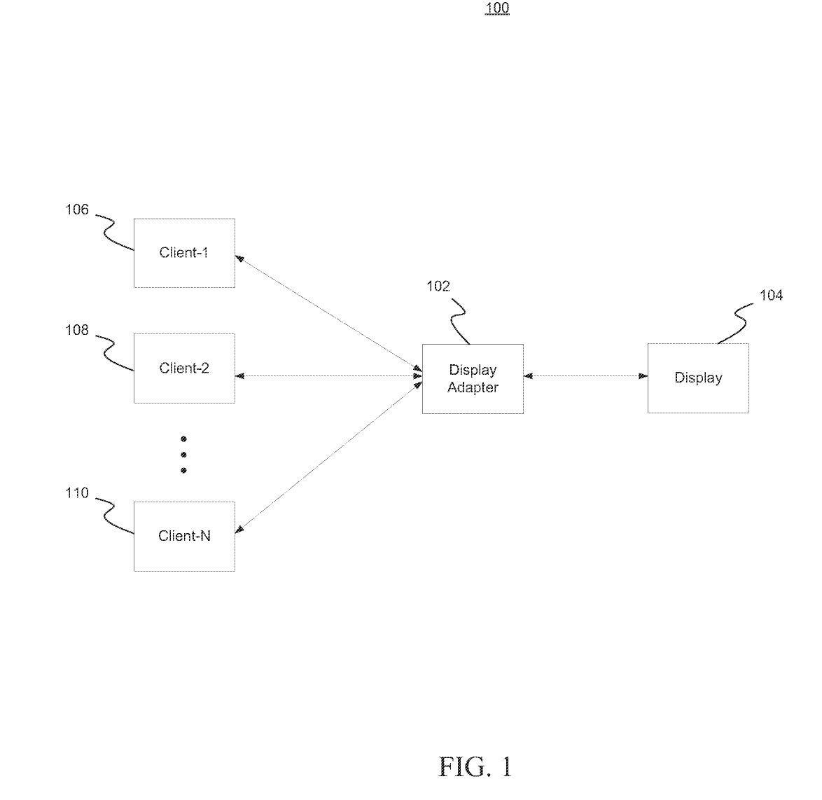

FIG. 1 illustrates a top level system diagram 100 of one exemplary embodiment consistent with the present disclosure. A display adapter 102 serves as an interface between display 104 and clients 106, 108, 110. As the system switches from one client, for example client-1 106, to another, for example client-2 108, the display adapter 102 transmits a new display mode and/or other display settings to display 104. Display adapter 102 determines the new display mode and/or settings in a manner that will be explained in greater detail below. Display mode and settings may include, for example, contrast, brightness, and any other settings the display 104 may be capable of supporting or adjusting. In some embodiments, display adapter 102 may be a wireless display docking station.

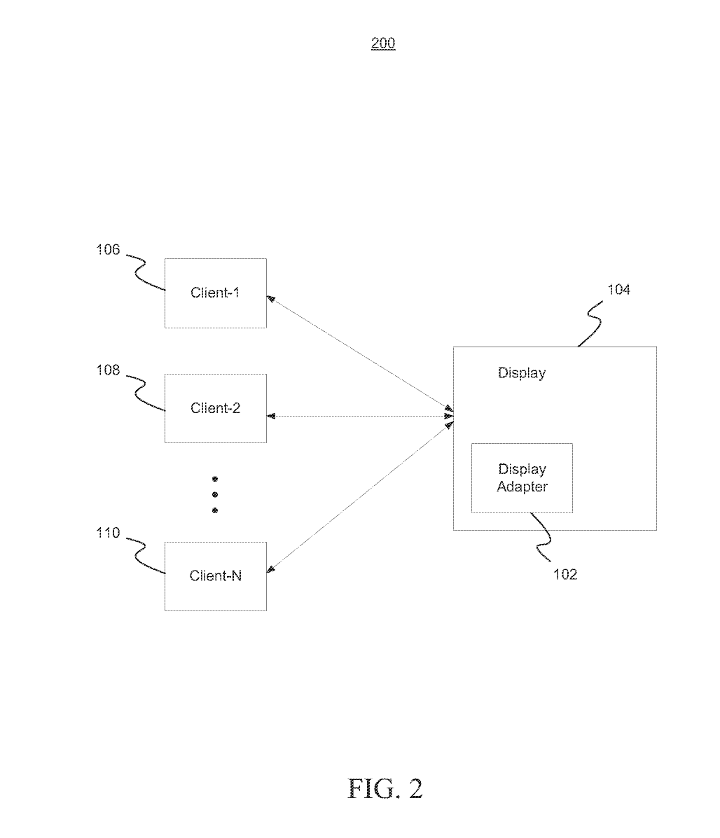

FIG. 2 illustrates a top level system diagram 200 of another exemplary embodiment consistent with the present disclosure. This embodiment is similar to that shown in FIG. 1, but illustrates that the display adapter 102 may be integrated with display 104.

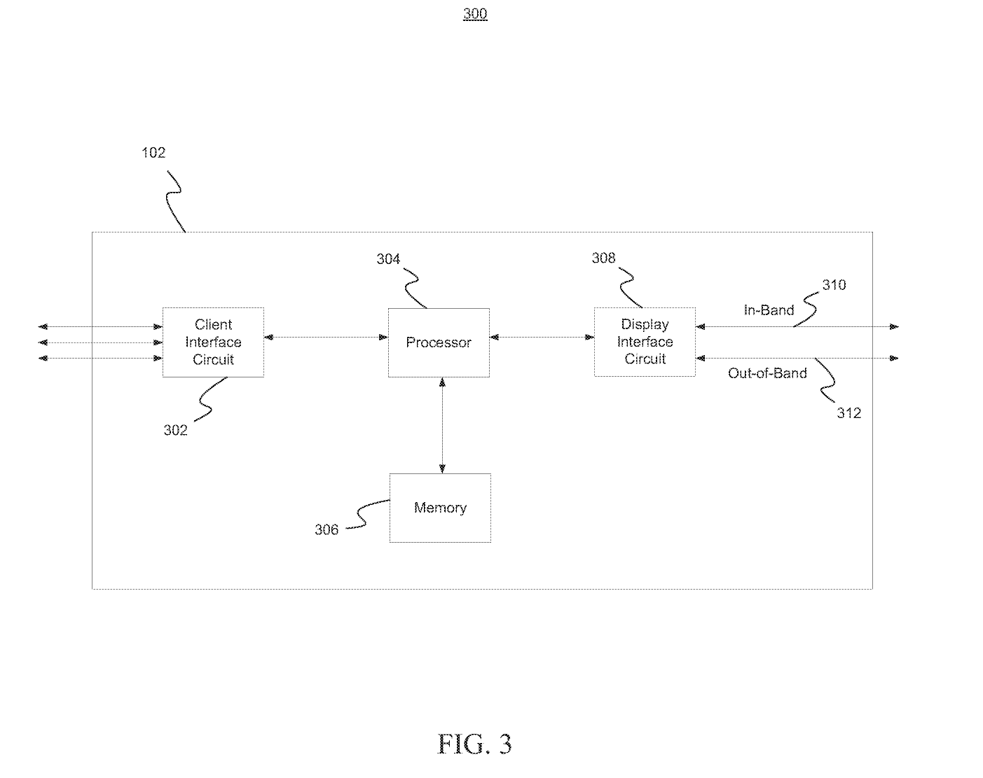

FIG. 3 illustrates a system block diagram 300 of one exemplary embodiment consistent with the present disclosure. Display adapter 102 is shown in greater detail to comprise client interface circuit 302, processor 304, memory 306 and display interface circuit 308. Display interface circuit 308 may communicate with display 104 through in-band channel 310 and/or out-of-band channel 312 as will be explained in greater detail below.

Client interface circuit 302 receives data from one of clients 106, 108, 110 that is currently connected to display adapter 102. This client data may comprise video data and control data. In some embodiments, the control data may include a client identification (ID). If a client ID is provided in the control data, the processor 304 may autonomously retrieve a desired display mode/setting associated with that client ID from memory 306. For example, the memory 306 may contain a list, or other suitable data structure, that pairs client IDs with a desired or default display mode/setting. The list or data structure maybe arranged to enable an efficient search so as to reduce the time required to find the display mode associated with the ID.

In some embodiments, the control data may include configuration setting messages comprising a requested display mode and/or other display settings, in which case the client is responsible for generating the messages. The messages may also comprise both a client ID and a display mode/setting, thus enabling the processor 304 to store the combination in memory 306 for future association.

Processor 304 may format the video data into a form suitable to the display 104. Display interface circuit 308 may transmit the desired display mode/settings along with the video data to display 104. In some embodiments, the display mode/settings may be transmitted in-band 310, for example on a channel, bus or video interface shared with the video data. Alternatively, the display mode/settings may be transmitted out-of-band 312, for example on a channel, bus or other interface that is separate from the video data.

In some embodiments, the client data may be received by client interface circuit 302 over a wireless connection. The wireless connection may be a Wi-Fi connection in accordance with any of the existing standards and/or future versions and/or derivatives thereof. The wireless connection may be configured to operate in the millimeter wave (mm-wave) region of the RF spectrum and, in particular, the 60 GHz region associated, for example, with the use of wireless personal area network (WPAN) and wireless local area network (WLAN) communication systems.

In some embodiments, the client data may be received by client interface circuit 302 over a wired display interface connection. The wired connection may comprise a High Definition Multimedia Interface (HDMI), a DisplayPort, a mechanical docking connection, a Universal Serial Bus (USB) or a wired local area network (LAN) operating in accordance with any of the existing standards and/or future versions and/or derivatives thereof.

An advantage of one more embodiments consistent with the present disclosure is that the display mode/settings for display 104 may be automatically updated as display adapter usage switches from one client to another, thus eliminating the need for manual adjustment of the settings through user interface commands on the display 104.

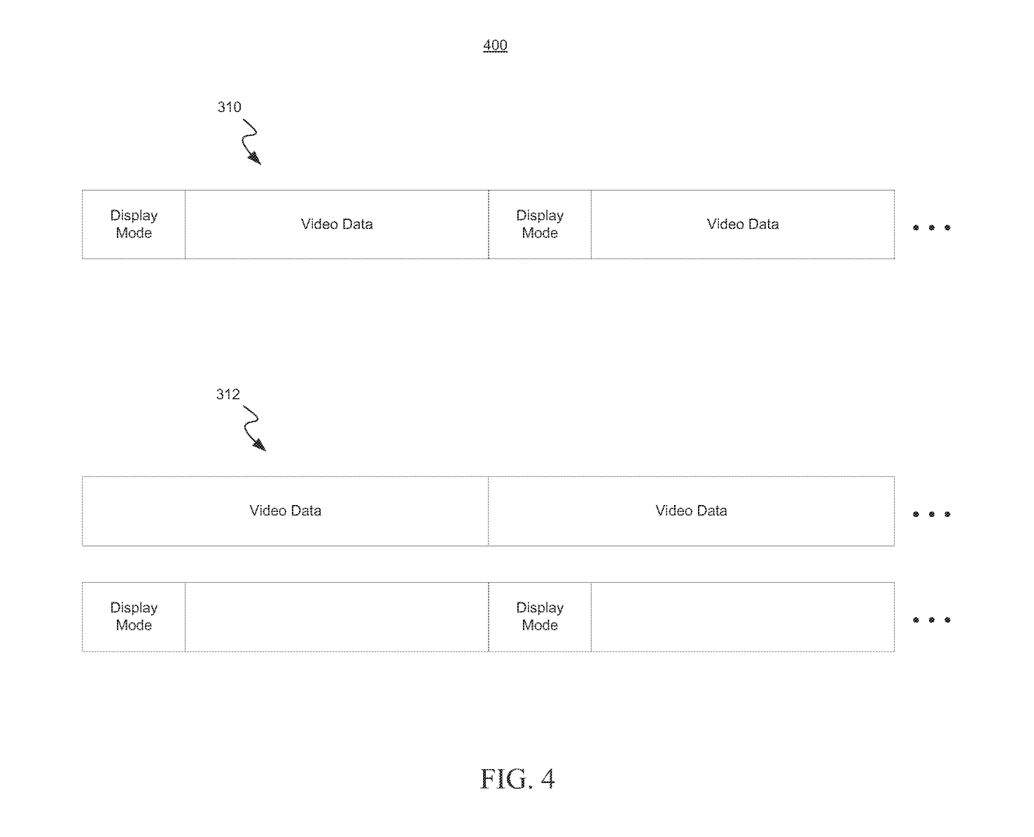

FIG. 4 illustrates a data channel 400 of one exemplary embodiment consistent with the present disclosure. Shown, is an in-band 310 data stream where the display mode is transmitted along with the video data, interspersed on the same channel. Also shown, is an out-of-band 312 data stream where the display mode is transmitted on a channel separate from the video data.

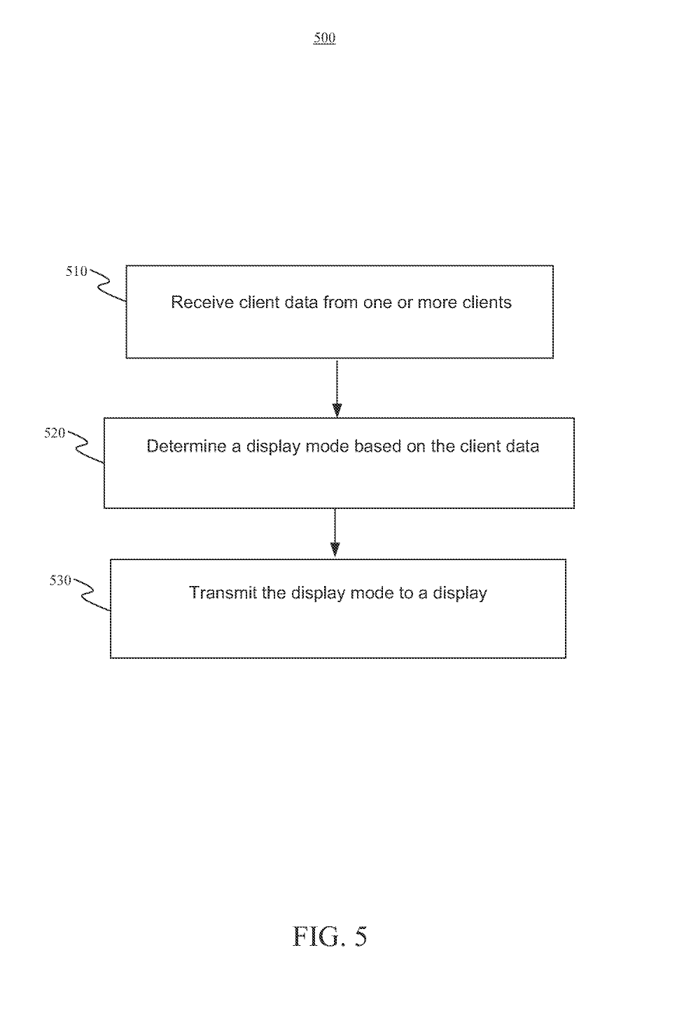

FIG. 5 illustrates a flowchart of operations 500 of one exemplary embodiment consistent with the present disclosure. At operation 510, client data is received from one or more clients. The clients are connected to a display adapter such as, for example, as wireless docking display adapter. At operation 520, a display mode is determined based on the client data. The display mode be contained in the client data or the display mode may be determined based on an association with a client ID that is contained in the client data. At operation 530, the display mode is transmitted to a display.

According to one aspect of the disclosure, there is thus provided an apparatus for a display adapter. The apparatus includes: a client interface circuit configured to receive client data from one or more clients; a processing circuit configured to determine a display mode based on the client data; and a display interface circuit configured to transmit the display mode to a display. The display interface circuit is further configured to embed the display mode within a video signal transmitted to the display and/or to transmit the display mode through a channel to the display which is separate from a video signal channel. The display adapter further includes a memory circuit and the processing circuit is further configured to associate a client identification with the display mode, where the client identification is included in the client data and the association is obtained from the memory circuit. The processing circuit is further configured to extract the display mode from a configuration settings message included in the client data. The client interface circuit may be further configured to receive the client data through a wireless receiver which may operate in accordance with a Wi-Fi standard and/or in a millimeter wave frequency range. The client interface circuit may also be configured to receive the client data through a wired interface such as a High Definition Multimedia Interface (HDMI), a DisplayPort, a mechanical docking connection, a Universal Serial Bus (USB) or a wired local area network (LAN). The display adapter may be integrated in the display.

According to another aspect of the disclosure, there is provided a method for interfacing a client to a display. The method includes: receiving client data from one or more clients; determining a display mode based on the client data; and transmitting the display mode to a display. The method further includes embedding the display mode within a video signal transmitted to the display and/or transmitting the display mode through a channel to the display which is separate from a video signal channel. The method further includes associating a client identification with the display mode, the client identification included in the client data. The method further includes extracting the display mode from a configuration settings message, the configuration setting message included in the client data. The method may further include receiving the client data wirelessly in accordance with a Wi-Fi standard and/or in a millimeter wave frequency range. The method may further include receiving the client data through a wired interface such as a High Definition Multimedia Interface (HDMI), a DisplayPort, a mechanical docking connection, a Universal Serial Bus (USB) or a wired local area network (LAN).

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-22. (canceled)

23. A display adapter, comprising:
a client interface circuit configured to receive client data from one or more clients;
a processing circuit configured to determine a display mode based on said client data; and
a display interface circuit configured to transmit said display mode to a display.

24. The display adapter of claim 23, wherein said display interface circuit is further configured to embed said display mode within a video signal transmitted to said display.

25. The display adapter of claim 23, wherein said display interface circuit is further configured to transmit said display mode through a channel to said display, said channel separate from a video signal channel.

26. The display adapter of claim 23, further comprising a memory circuit and wherein said processing circuit is further configured to associate a client identification with said display mode, said client identification included in said client data and said association obtained from said memory circuit.

27. The display adapter of claim 23, wherein said processing circuit is further configured to extract said display mode from a configuration settings message, said configuration setting message included in said client data.

28. The display adapter of claim 23, wherein said client interface circuit is further configured to receive said client data through a wireless receiver.

29. The display adapter of claim 28, wherein said wireless receiver is configured to operate with a Wireless Fidelity (Wi-Fi) interface.

30. The display adapter of claim 28, wherein said wireless receiver is configured to operate in a millimeter wave frequency range.

31. The display adapter of claim 23, wherein said display adapter is integrated in said display.

32. The display adapter of claim 23, wherein said client interface circuit is further configured to receive said client data through a wired interface.

33. The display adapter of claim 32, wherein said wired interface comprises one or more items selected from a list of items consisting of a High Definition Multimedia Interface (HDMI), a Display Port, a mechanical docking connection, a Universal Serial Bus (USB), and a wired local area network (LAN).

34. A method for interfacing a client to a display, comprising:
receiving client data from one or more clients;
determining a display mode based on said client data; and
transmitting said display mode to a display.

35. The method of claim 34, further comprising embedding said display mode within a video signal transmitted to said display.

36. The method of claim 34, further comprising transmitting said display mode through a channel to said display, said channel separate from a video signal channel.

37. The method of claim 34, further comprising associating a client identification with said display mode, said client identification included in said client data.

38. The method of claim 34, further comprising extracting said display mode from a configuration settings message, said configuration setting message included in said client data.

39. The method of claim 34, wherein said client data is received wirelessly.

40. The method of claim 39, wherein said wireless reception is through a Wi-Fi interface.

41. The method of claim 39, wherein said wireless reception operates in a millimeter wave frequency range.

42. The method of claim 34, wherein said client data is received through a wired interface.

43. The method of claim 42, wherein said wired interface comprises one or more items selected from a list of items consisting of a High Definition Multimedia Interface (HDMI), a Display Port, a mechanical docking connection, a Universal Serial Bus (USB), and a wired local area network (LAN).

44. A non-transitory computer-readable storage medium having instructions stored thereon which when executed by a processor result in the following operations comprising:
receiving client data from one or more clients;
determining a display mode based on said client data; and
transmitting said display mode to a display.

45. The non-transitory computer-readable storage medium of claim 44, wherein said operations further comprise embedding said display mode within a video signal transmitted to said display.

46. The non-transitory computer-readable storage medium of claim 44, wherein said operations further comprise transmitting said display mode through a channel to said display, said channel separate from a video signal channel.

47. The non-transitory computer-readable storage medium of claim 44, wherein said operations further comprise associating a client identification with said display mode, said client identification included in said client data.

48. The non-transitory computer-readable storage medium of claim 44, wherein said operations further comprise extracting said display mode from a configuration settings message, said configuration setting message included in said client data.
